(19) United States
(12) Patent Application Publication
(10) Pub. No.: US 2022/0324565 A1
(43) Pub. Date: Oct. 13, 2022

(54) UNMANNED AERIAL VEHICLE

(71) Applicant: AUTEL ROBOTICS CO., LTD., Shenzhen (CN)

(72) Inventors: Tianbao ZHANG, Shenzhen (CN); Yingjie Li, Shenzhen (CN)

(21) Appl. No.: 17/650,683

(22) Filed: Feb. 11, 2022

Related U.S. Application Data
(63) Continuation of application No. PCT/CN2020/108931, filed on Aug. 13, 2020.

(30) Foreign Application Priority Data
Aug. 14, 2019 (CN) 201910749520.5

(51) Int. Cl. B64C 39/02; B64D 27/26

(52) U.S. Cl. CPC B64C 39/024; B64D 27/26; B64C 2201/108

(57) ABSTRACT

Embodiments of the present invention discloses an unmanned aerial vehicle, comprising: a fuselage, the centroid of the unmanned aerial vehicle being located on the fuselage; an arm connected to the fuselage; and a motor, wherein the motor is obliquely mounted on the arm, the projection of the inclination direction of the motor on a horizontal plane forms a preset angle with a connecting line between the motor and the centroid, and the inclination direction of the motor forms an acute angle with the vertical direction.

### CROSS REFERENCE

The present application is a continuation of the International Application No. PCT/CN2020/108931, filed on Aug. 13, 2020, which claims priority to the Chinese patent application No. 201910749520.5, filed on Aug. 14, 2019, which is incorporated herein by reference in its entirety.

### TECHNICAL FIELD

The present application relates to the field of unmanned aerial vehicles, and more particularly to a multi-rotor unmanned aerial vehicle.

### RELATED ART

The unmanned aerial vehicle (UAV), having the advantages of maneuverability, flexibility, rapid response, unmanned driving, and low operating requirements, is new concept equipment in rapid development. The unmanned aerial vehicle (UAV), which can realize real-time image transmission and high-risk area detection function by carrying multiple types of sensors or camera devices, is a powerful supplement to satellite remote sensing and traditional aerial remote sensing. At present, the application range of unmanned aerial vehicles has expanded to military, scientific research, and civilian fields, and unmanned aerial vehicles are especially widely used in the fields of electric power telecommunication, meteorology, agriculture, ocean, exploration, photography, disaster prevention and mitigation, crop yield estimation, drug enforcement and anti-smuggling, border patrol, public security and anti-terrorism, etc.

The motor of unmanned aerial vehicles is generally vertically mounted on the fuselage of an unmanned aerial vehicle.

However, in carrying out the present invention, the inventors found the fast performance of the yaw control channel of a motor-driven aircraft. Therefore, the prior art needs to be improved.

### SUMMARY

In order to solve the above technical problem, embodiments of the present invention provide an unmanned aerial vehicle, showing the fast performance of the yaw control channel of a motor-driven aircraft.

In order to solve the above technical problem, embodiments of the present invention provide the following technical solution.

An unmanned aerial vehicle is provided, comprising: a fuselage, wherein, the centroid of the unmanned aerial vehicle is located on the fuselage; an arm connected to the fuselage; and a motor obliquely mounted to the arm, wherein the projection of the inclination direction of the motor on the horizontal plane is at a preset angle with the line connecting the motor and the centroid, and the inclination direction of the motor is at an acute angle with the vertical direction.

In some embodiments, the fuselage includes a nose and a tail opposite the nose. The motor includes: a first motor and a second motor respectively located at two sides of the nose; and a third motor and a fourth motor respectively located at two sides of the tail; wherein the inclination direction of the first motor is opposite to that of the third motor; the inclination direction of the second motor is opposite to that of the fourth motor.

In some embodiments, the mounting planes of the first motor and the second motor are the same, and the mounting planes of the third motor and the fourth motor are the same; a drop is formed between the mounting planes of the first motor and the second motor, and the mounting planes of the third motor and the fourth motor.

In some embodiments, the included angle between the first motor and the vertical direction is equal to the included angle between the second motor and the vertical direction; and the included angle between the third motor and the vertical direction is equal to the included angle between the fourth motor and the vertical direction.

In some embodiments, the mounting planes of the first motor and the second motor are higher than the mounting planes of the third motor and the fourth motor.

In some embodiments, the included angle between the first motor and the vertical direction is smaller than the included angle between the third motor and the vertical direction; or the included angle between the second motor and the vertical direction is smaller than the included angle between the fourth motor and the vertical direction.

In some embodiments, the mounting planes of the first motor and the second motor are smaller than the mounting planes of the third motor and the fourth motor.

In some embodiments, the included angle between the first motor and the vertical direction is greater than the included angle between the third motor and the vertical direction; or the included angle between the second motor and the vertical direction is greater than the included angle between the fourth motor and the vertical direction.

In some embodiments, the included angle between the motor and the vertical direction satisfies:

$$\frac{{l}_{1}}{tan {α}_{1} sin ( arctan ( \frac{{s}_{1}}{{l}_{1}} ) )} + d = \frac{{l}_{2}}{tan {α}_{2} sin ( arctan ( \frac{{s}_{2}}{{l}_{2}} ) )}$$

where S₁ is the shortest distance from an intersection point of motor shafts of the first motor or the second motor and the horizontal plane to a central axis of the fuselage, S₂ is a distance from the intersection point of the motor shafts of the third motor or fourth motor and the horizontal plane to the central axis of the fuselage, l₁ is the distance from the intersection point of the motor shafts of the first motor or the second motor and the horizontal plane to a plane perpendicular to the central axis of the fuselage, l₂ is the distance from the intersection point of the motor shafts of the third motor or the fourth motor and the horizontal plane to the plane perpendicular to the central axis of the fuselage, α₁ is the included angle between the first motor or the second motor and the vertical direction, and α₂ is the included angle between the third motor or the fourth motor and the vertical direction.

In some embodiments, the preset angle ranges from 30° to 150°.

In some embodiments, the preset angle is 90°.

In some embodiments, the included angle between the motor and the vertical direction is no greater than 15°.

In some embodiments, the unmanned aerial vehicle further includes a motor mount to which the motor is mounted, the motor mount being mounted obliquely to the arm, and the motor mount being at an angle to the horizontal plane that is equal to the angle between the motor and the vertical direction.

Compared with the prior art, in an unmanned aerial vehicle according to an embodiment of the present invention, a motor is obliquely arranged. The motor has one control component on the yaw control channel, and the control component is perpendicular to the connecting line between the motor and the centroid. The projection of the inclination direction of the motor on the horizontal plane is configured to form a preset angle with the connecting line between the motor and the centroid, and the control component of the motor on the yaw control channel can be improved by adjusting the preset angle. In addition, the inclination direction of the motor forms an acute angle with the vertical direction, the inclination direction of the motor forms an acute angle with the vertical direction, and the cosine value of the included angle between the inclination angle and the vertical direction is close to 1, which has little influence on the height control channel. Furthermore, the limit cycle of the unmanned aerial vehicle in hover is reduced such that the stability and control accuracy of the unmanned aerial vehicle in hover are increased.

### BRIEF DESCRIPTION OF THE DRAWINGS

One or more embodiments are exemplified by the accompanying drawings corresponding thereto. These exemplified descriptions do not constitute a limitation on the embodiments. Elements in the drawings having the same reference number designations are illustrated as similar elements, and unless otherwise particularly stated, the drawings do not constitute a proportional limitation.

FIG. 1 is a plan view of an unmanned aerial vehicle provided by one of the embodiments of the present invention, wherein the viewing angle of the view is in a first pitching direction;

FIG. 2 is a perspective view of the unmanned aerial vehicle shown in FIG. 1;

FIG. 3a is a projection view in the plane X₁O₁Z₁ of an inclination direction of a first motor of the unmanned aerial vehicle shown in FIG. 2;

FIG. 3b is a projection view in the plane Y₁O₁Z₁ of the inclination direction of the first motor of the unmanned aerial vehicle shown in FIG. 2;

FIG. 4a is a projection view in the plane X₂O₂Z₂ of the inclination direction of a second motor of the unmanned aerial vehicle shown in FIG. 2;

FIG. 4b is a projection view of the inclination direction of the second motor of the unmanned aerial vehicle shown in FIG. 2 in the plane X₂O₂Z₂;

FIG. 5a is a projection view in the plane X₃O₃Z₃ of the inclination direction of a third motor of the unmanned aerial vehicle shown in FIG. 2;

FIG. 5b is a projection view in the plane X₃O₃Z₃ of the inclination direction of the third motor of the unmanned aerial vehicle shown in FIG. 2;

FIG. 6a is a projection view in the plane X₄O₄Z₄ of the inclination direction of a fourth motor of the unmanned aerial vehicle shown in FIG. 2;

FIG. 6b is a projection view in the plane Y₄O₄Z₄ of the inclination direction of the fourth motor of the unmanned aerial vehicle shown in FIG. 2;

FIG. 7 is a schematic view of the direction of a rotating vector of the inclination angles of each motor of the unmanned aerial vehicle shown in FIG. 1;

FIG. 8 is a schematic view of dimensional parameters of the unmanned aerial vehicle shown in FIG. 1;

FIG. 9 is a schematic view of motor mounting of the unmanned aerial vehicle shown in FIG. 1.

### DETAILED DESCRIPTION

In order to make the present invention readily understood, a more detailed description of the present invention will be rendered with reference to the appended drawings and specific implementation modes. It should be noted that when an element is referred to as being “secured” to another element, it can be directly on the other element or one or more intervening elements may be present therebetween. When one element is referred to as being “connected” to another element, it can be directly connected to the other element or one or more intervening elements may be present therebetween. The terms “vertical”, “horizontal”, “left”, “right”, “inner”, “outer”, and the like used herein are for descriptive purposes only.

Unless defined otherwise, all technical and scientific terms used in the description have the same meaning as commonly understood by one of ordinary skill in the art to which the present invention belongs. The terminology used in the description of the present invention is for the purpose of describing specific implementation modes only and is not intended to limit the present invention. As used herein, the term “and/or” includes any and all combinations of one or more of the associated listed items.

In the field of unmanned aerial vehicles (UAVs), in order to improve the control ability of the yaw channel, the control is generally achieved by increasing the reactive torque of a blade. However, the reactive torque of the blade is very small and the control ability is weak, especially when the UAV has a certain mass.

Referring to FIG. 1, an unmanned aerial vehicle 100 provided by one of the embodiments of the present invention includes a fuselage 10, a motor 20, and an arm 30. The centroid G of the unmanned aerial vehicle 100 is located on the fuselage 10, the arm 30 is connected to the fuselage 10, the motor 20 is obliquely mounted on the arm 30, the projection of the inclination direction of the motor 20 on the horizontal plane is at a preset angle with the line connecting the motor 20 and the centroid G, and the inclination direction of the motor 20 is at an acute angle with the vertical direction.

It should be noted that the above-mentioned horizontal plane is a dummy reference plane, which is parallel to the ground, and the vertical direction is perpendicular to the ground.

It is worth explaining that the motor is obliquely arranged. The motor has one control component on the yaw control channel, and the control component is perpendicular to the connecting line between the motor and the centroid. The projection of the inclination direction of the motor on the horizontal plane is configured to form a preset angle with the connecting line between the motor and the centroid, and the control component of the motor on the yaw control channel can be improved by adjusting the preset angle. In addition, the inclination direction of the motor forms an acute angle with the vertical direction, the inclination direction of the motor forms an acute angle with the vertical direction, and the cosine value of the included angle between the inclination angle and the vertical direction is close to 1, which has little influence on the height control channel.

Furthermore, the limit cycle of the unmanned aerial vehicle in hover is reduced such that the stability and control accuracy of the unmanned aerial vehicle in hover are increased.

In some embodiments, the preset angle ranges from 30 degrees to 150 degrees, and preferably the preset angle is 90 degrees. By configuring the preset angle to be 90 degrees, the utilization ratio of the component force of the motor in the horizontal direction in the yaw control channel is 100%, and the component force in the horizontal direction does not interfere with other control channels. According to the actual situation, by slightly adjusting the angle of inclination, there is no great influence, and the present invention cannot exhaustively enumerate all inclination orientations. It falls within the scope of the present invention as long as the preset angle ranges from 30 degrees to 150 degrees.

In some embodiments, the included angle between the inclination direction of the motor 20 and the vertical direction is not greater than 15 degrees.

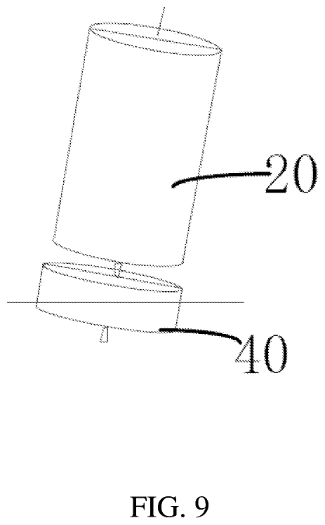

In some embodiments, referring to FIG. 9, the unmanned aerial vehicle 100 further includes a motor mount 40 to which the motor 20 is mounted, the motor mount 40 being mounted obliquely to the arm, and the motor mount 40 being at an angle to the horizontal plane that is equal to the angle between the motor 20 and the vertical direction.

In some embodiments, the motor 20 is fixedly mounted to the mechanical arm 30, and the inclination angle of the motor 20 is a fixed value, in comparison with a motor movably mounted to the mechanical arm, and driven by a tilt motor to adjust the inclination angle of the motor. The motor is fixedly mounted to the mechanical arm, avoiding the use of a tilt motor to reduce cost. In fact, the tilt motor does not improve the control performance of the unmanned aerial vehicle 100 under normal flight conditions.

Specific implementation modes of some unmanned aerial vehicles are described below. It should be noted that the following is merely exemplary, and other unmanned aerial vehicles capable of satisfying at least one of the above situations are within the scope of the present application.

In addition, in order to facilitate the description of the specific orientation of each member of the unmanned aerial vehicle, based on the aforementioned vertical direction and horizontal plane, four orientations are introduced, i.e. front, rear, left, and right, all parallel to the horizontal plane, wherein the front and rear directions are perpendicular to the left and right directions.

The fuselage 10 has a bar shape or a shuttle shape as a whole, and has a nose 11 and a tail 12. The nose 11 is located forward of the centroid G and the tail 12 is located rearward of the centroid G.

Depending on actual circumstances, the fuselage 10 is not limited to a shuttle shape. For example, the fuselage 10 takes the form of a rotating body about a vertical axis that approaches or passes through the centroid G.

The motor 20 includes a first motor 20a, a second motor 20b, a third motor 20c, and a fourth motor 20d. The first motor 20a and the second motor 20b are respectively located on two sides of the nose 11, and the third motor 20c and the fourth motor 20d are respectively located on two sides of the tail 12. The inclination direction of the first motor is opposite to that of the third motor, and the inclination direction of the second motor is opposite to that of the fourth motor.

The first motor 20a is located at the front left of the centroid G, and the first motor 20a is inclined to the lower left; the second motor 20b is located at the upper right of the centroid G, and the second motor 20b is inclined to the lower right; the third motor 20c is located at the lower left of the centroid G, and the third motor 20c is inclined to the upper left; the fourth motor 20d is located at the lower right of the centroid G, and the fourth motor 50 is inclined to the upper right.

It needs to be noted that the motor (the first motor, the second motor, the third motor, and the fourth motor) is inclined in one direction, meaning that the connection point between the motor and the arm is a fulcrum, and one end of the motor, on which a propeller is mounted, rotates around the fulcrum and in the direction.

The arm 30 includes a first arm 30a, a second arm 30b, a third arm 30c, and a fourth arm 30d. The first arm 30a is connected to the fuselage 10, and the first motor 20a is obliquely mounted to the first arm 30a. Similarly, the second arm 30b is connected to the fuselage 10, and the second motor 20b is obliquely mounted to the second arm 30b. The third arm 30c is connected to the fuselage 10, and the third motor 20c is obliquely mounted to the third arm 30c. The fourth arm 30d is connected to the fuselage 10, and the fourth motor 20d is obliquely mounted to the fourth arm 30d.

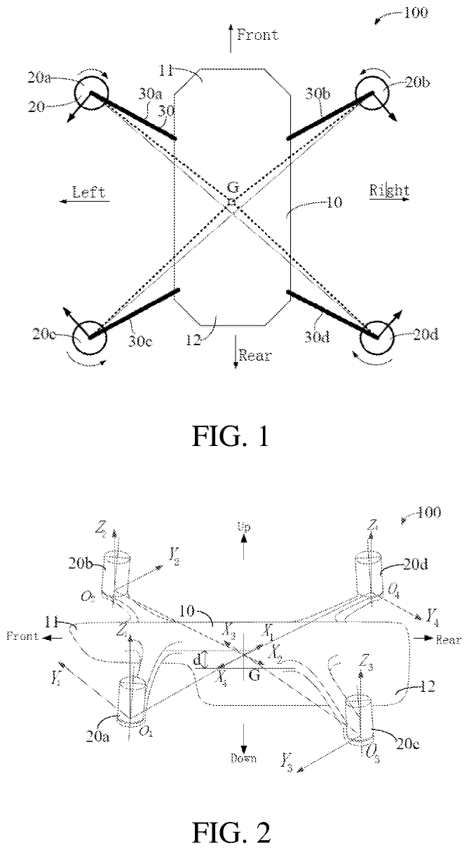

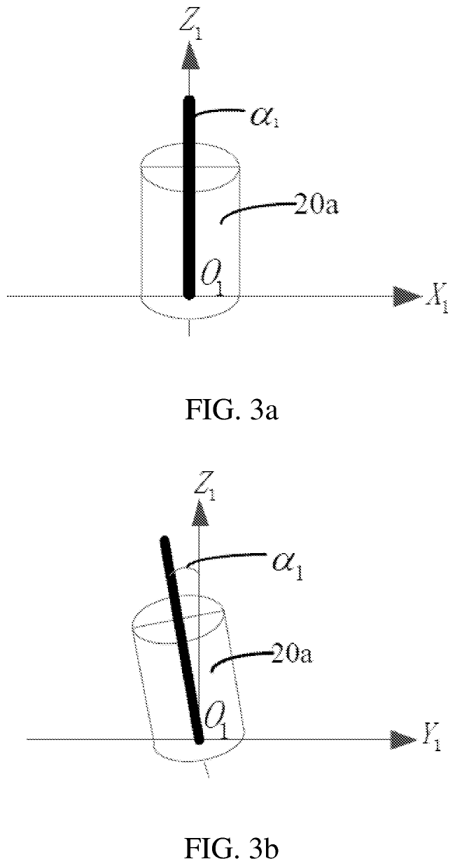

Referring to FIGS. 2, 3a, and 3b, a first rectangular coordinate system is constructed on the first motor 20a, and the origin of the first rectangular coordinate system is set as the joint of the first motor 20a and the first arm 30a, setting as O₁. The axis of the first rectangular coordinate system X₁ passes through O₁ and the centroid G, and axis X₁ directs from O₁ to the centroid G. The axis Z₁ of the first rectangular coordinate system passes through O₁, and the axis Z₁ directs upwards in the vertical direction. The axis Y₁ of the first rectangular coordinate system passes through O₁, and the axis Y₁ directs along the front right. Any two of the axis X₁, axis Y₁ and Z₁ axis are perpendicular to each other. The projection of the inclination direction of the first motor 20 on the X₁O₁Z₁ plane coincides with the positive axis of the axis Z₁. The projection of the inclination direction of the first motor 20 on the Y₁O₁Z₁ plane is in the second quadrant of the Y₁O₁Z₁ plane, and the projection of the inclination direction of the first motor 20 on the X₁O₁Y₁ plane coincides with the negative axis of the axis 1.

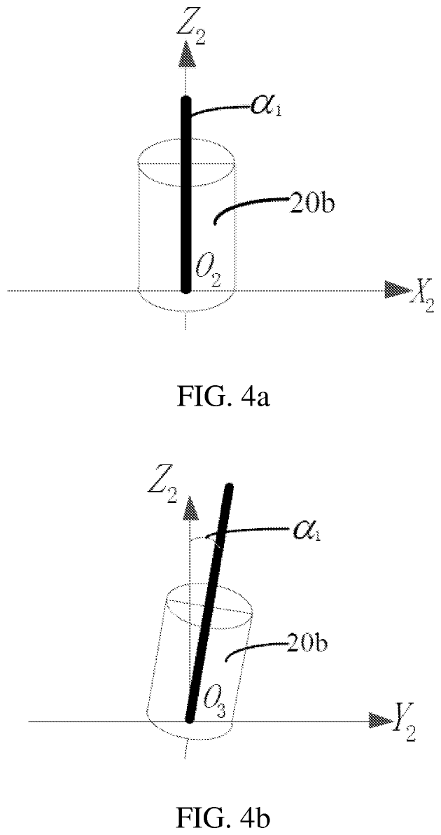

Referring to FIGS. 2, 4a, and 4b, a second rectangular coordinate system is constructed on the second motor 20b, and the origin of the second rectangular coordinate system is the joint of the second motor 20b and the second arm 30b, setting as O₂. The axis X₂ of the second rectangular coordinate system passes through O₂ and the centroid G, and the axis X₂ directs from O₂ to the centroid G. The axis Z₂ of the second rectangular coordinate system passes through O₂, and the axis Z₂ directs upwards along the vertical direction. The axis Y₂ of the second rectangular coordinate system passes through O₂, and the axis Y₂ directs along the lower right direction. Any two of the axis X₂, axis Y₂, and axis Z₂ are perpendicular to each other. The projection of the inclination direction of the second motor 20b on the X₂O₂Z₂ plane coincides with the positive axis of the axis 2. The projection of the inclination direction of the second motor 20b on the Y₂O₂Z₂ plane is in the first quadrant of the Y₂O₂Z₂ plane, and the projection of the direction of the second motor 20b on the X₂O₂Y₂ plane coincides with the positive axis of the axis Y₂.

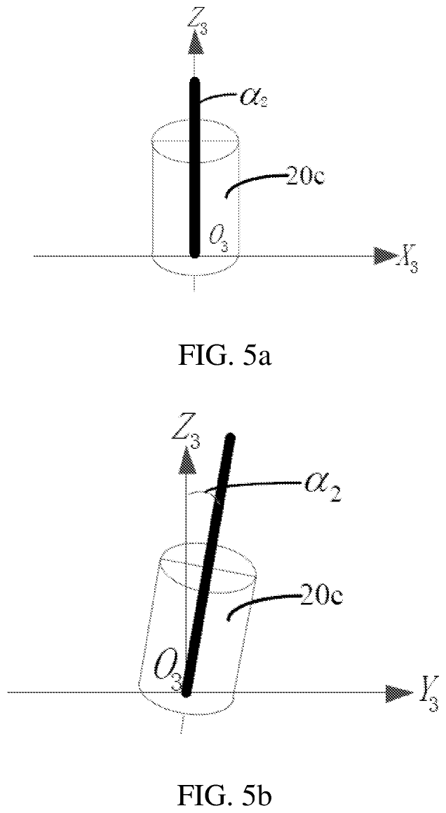

Referring to FIGS. 2, 5a, and 5b, a second rectangular coordinate system is constructed on the third motor 20c, and the origin of the second rectangular coordinate system is the joint of the third motor 20c and the third arm 30c, setting as O₃. The axis X₃ of the third rectangular coordinate system passes through O₃ and the centroid G, and the axis X₃ directs from O₃ to the centroid G. The axis Z₃ of the third rectangular coordinate system passes through O₃, and axis Z₃ directs upwards in the vertical direction. The axis Y₃ of the third rectangular coordinate system passes through O₃, and the axis Y₃ directs along the upper left. Any two of the axis X₃, axis Y₃, and axis Z₃ are perpendicular to each other. The projection of the inclination direction of the third motor 20c on the X₃O₃Z₃ plane coincides with the positive axis of the axis Z₃. The projection of the inclination direction of the third motor 20c on the Y₃O₃Z₃ plane is in the first quadrant of the Y₃O₃Z₃ plane, and the projection of the inclination direction of the third motor 20c on X₃O₃Y₃ coincides with the positive axis of the axis Y₃.

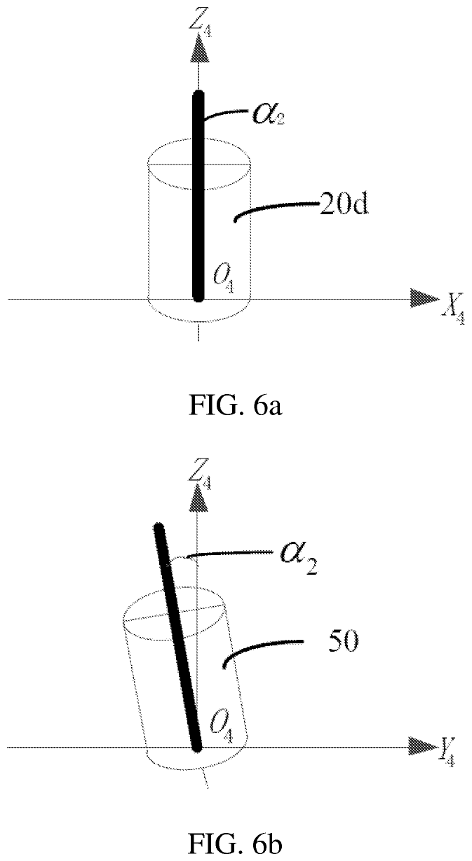

Referring to FIGS. 2, 6a, and 6b, a fourth rectangular coordinate system is constructed on the fourth motor 20d, and the origin of the fourth rectangular coordinate system is the joint of the fourth motor 20d and the fourth arm 30d, setting as O₄. The axis X₄ of the fourth rectangular coordinate system passes through O₄ and the centroid G, and the axis X₄ directs from O₄ to the centroid G. The axis Z₄ of the fourth rectangular coordinate system passes through O₄, and the axis Z₄ directs upwards in the vertical direction. The axis Y₄ of the third rectangular coordinate system passes through O₄, and the axis Y₄ directs along the lower right direction. Any two of the axis, axis Y₄, and axis Z₄ are perpendicular to each other. The projection of the inclination direction of the fourth motor 20d on the X₄O₄Z₄ plane coincides with the positive axis of the axis Z₄. The projection of the inclination direction of the fourth motor 20d on the Y₄O₄Z₄ plane is in the second quadrant of the Y₄O₄Z₄ plane, and the projection of the inclination direction of the fourth motor 20d on the X₄O₄Y₄ plane coincides with the negative axis of the axis Y₄.

The first motor 20a is left-right symmetric with the second motor 20b, and the third motor 20c is left-right symmetric with the fourth motor 20d.

The included angle between the first motor 20a and the vertical direction is equal to the included angle between the second motor 20b and the vertical direction. The included angle between the third motor 20c and the vertical direction is equal to the included angle between the fourth motor 20d and the vertical direction.

The first motor 20a has the same mounting plane as the second motor 20b, and the third motor 20c has the same mounting plane as the fourth motor 20d. A drop d is formed between the mounting planes of the first motor 20a and the second motor 20b, and the mounting planes of the third motor 20c and the fourth motor 20d.

The mounting planes of the first motor 20a and the second motor 20b are higher than the mounting planes of the third motor 20c and the fourth motor 20d. The included angle between the first motor 20a and the vertical direction is smaller than the included angle between the third motor 20c and the vertical direction. The included angle between the second motor 20b and the vertical direction is smaller than the included angle between the fourth motor 20d and the vertical direction.

In some other embodiments, the mounting planes of the first motor 20a and the second motor 20b are lower than the mounting planes of the third motor 20c and the fourth motor 20d. The included angle between the first motor 20a and the vertical direction is greater than the included angle between the third motor 20c and the vertical direction. The included angle between the second motor 20b and the vertical direction is greater than the included angle between the fourth motor 20d and the vertical direction.

The first motor 20a rotates in the same direction as the fourth motor 20d, and the second motor 20b and the third motor 20c rotate in opposite directions to the first motor 20a.

In the present embodiment, the first motor 20a and the fourth motor 20d rotate in a clockwise direction, and the second motor 20b and the third motor 20c rotate in a counterclockwise direction.

It is worth mentioning that, based on the balance and control considerations of the unmanned aerial vehicle, by configuring adjacent motors with different rotation directions, the component forces provided by the adjacent motors cancel each other in terms of the balance of the unmanned aerial vehicle such that the balance is good; with regard to the control of the unmanned aerial vehicle, when the unmanned aerial vehicle is steered, it is driven only by the component force provided by two diagonally located motors such that the steering efficiency is high.

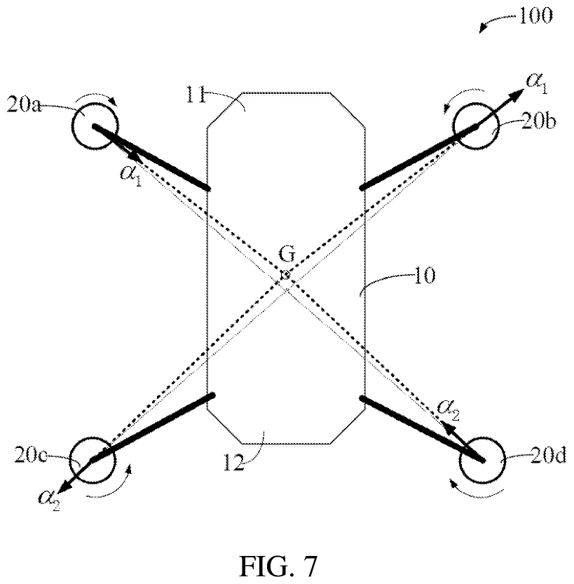

Referring to FIG. 7, an embodiment of the present invention describes the included angle between the inclination direction of each motor and the vertical direction, i.e. the inclination angle, by the rotating vector method of the right-hand rule.

In the first motor 20a, second motor 20b, third motor 20c, and fourth motor 20d, the included angle between the inclination direction of the motor and the vertical direction is the magnitude of the rotating vector of the inclination angle, setting as α₁, α₂, α₃, and α₄. According to the right-hand rule, four fingers of the right hand are bent in this direction of rotation, the thumb pointing in the direction of the rotating vector of the inclination angle.

The magnitude of the rotating vector of the inclination angle of the first motor 20a is α₁. The direction of the rotating vector of the inclination angle of the first motor 20a is along the connecting line of the centroid G and the first motor 20b, directing from the first motor 20b to the centroid G.

Since the inclination directions of the second motor 20b and the first motor 20a have the same included angle with the vertical direction, the magnitude of the rotating vector of the inclination angle of the second motor 20b is also α₁. The direction of the rotating vector of the inclination angle of the second motor 20b is along the connecting line of the centroid G and the second motor 20b, directing from the centroid G to the second motor 20b.

The magnitude of the rotating vector of the inclination angle of the third motor 20c is α₂. The direction of the rotating vector of the inclination angle of the third motor 20c is along the connecting line of the centroid G and the third motor 20c, directing from the centroid G to the third motor 20c.

Since the included angles between the inclination directions and the vertical direction of the fourth motor 20d and the third motor 20c are equal, the magnitude of the rotating vector of the inclination angle of the fourth motor 20d is also α₂. The direction of the rotating vector of the inclination angle of the fourth motor 20d is along the connecting line of the centroid G and the fourth motor 20d, directing from the fourth motor 20d to the centroid G.

In some other embodiments, the first motor 20a and the fourth motor 20d rotate in a counterclockwise direction, and the second motor 20b and the third motor 20c rotate in a clockwise direction. The direction of the rotating vector of the inclination angle of the first motor 20a is directed from the centroid G to the second motor 20b. The direction of the rotating vector of the inclination angle of the second motor 20b is directed from the second motor 20b to the centroid G. The direction of the rotating vector of the inclination angle of the third motor 20c is directed from the third motor 20c to the centroid G. The direction of the rotating vector of the inclination angle of the fourth motor 20d is directed from the centroid G to the fourth motor 20d.

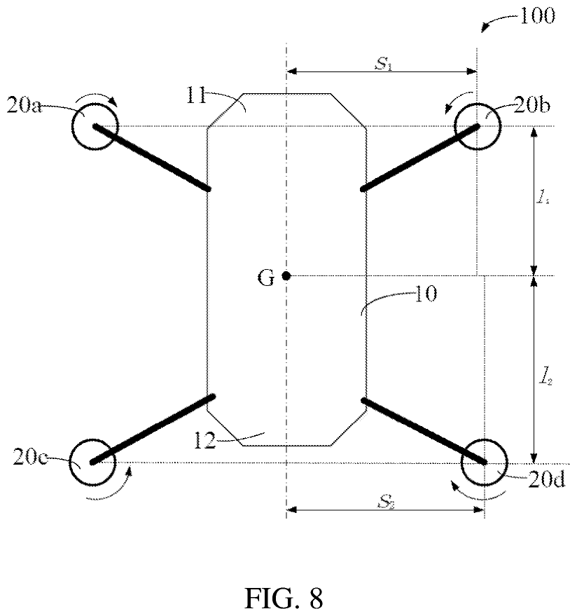

With reference to FIG. 8, the included angle between the motor and the vertical direction satisfies:

$$\frac{{l}_{1}}{tan {α}_{1} sin ( arctan ( \frac{{s}_{1}}{{l}_{1}} ) )} + d = \frac{{l}_{2}}{tan {α}_{2} sin ( arctan ( \frac{{s}_{2}}{{l}_{2}} ) )}$$

$$or$$

$$\frac{{l}_{1} \sqrt{{l}_{1}^{2} Δ + {s}_{1}^{2}}}{{s}_{1} tan {α}_{1}} + d = \frac{{l}_{2} \sqrt{{l}_{2}^{2} Δ + {s}_{2}^{2}}}{{s}_{2} tan {α}_{2}}$$

where S₁ is the shortest distance from the intersection point of the motor shafts of the first motor or the second motor and the horizontal plane to the central axis of the fuselage, S₂ is the distance from the intersection point of the motor shafts of the third motor or fourth motor and the horizontal plane to the central axis of the fuselage, l₁ is the distance from the intersection point of the motor shafts of the first motor or the second motor and the horizontal plane to the plane perpendicular to the central axis of the fuselage, l₂ is the distance from the intersection point of the motor shafts of the third motor or the fourth motor and the horizontal plane to the plane perpendicular to the central axis of the fuselage, α₁ is the included angle between the first motor or the second motor and the vertical direction, and α₂ is the included angle between the third motor or the fourth motor and the vertical direction.

Compared with the prior art, embodiments of the present invention provide an unmanned aerial vehicle 100. A motor is obliquely arranged. The motor has one control component on the yaw control channel, and the control component is perpendicular to the connecting line between the motor and the centroid. The projection of the inclination direction of the motor on the horizontal plane is configured to form a preset angle with the connecting line between the motor and the centroid, and the control component of the motor on the yaw control channel can be improved by adjusting the preset angle. In addition, the inclination direction of the motor forms an acute angle with the vertical direction, the inclination direction of the motor forms an acute angle with the vertical direction, and the cosine value of the included angle between the inclination angle and the vertical direction is close to 1, which has little influence on the height control channel. Furthermore, the limit cycle of the unmanned aerial vehicle in hover is reduced such that the stability and control accuracy of the unmanned aerial vehicle in hover are increased.

Finally, it should be noted that: the above embodiments are merely illustrative of the technical solutions of the present invention, rather than limiting it; combinations of technical features in the above embodiments or in different embodiments are also possible under the idea of the present invention, and the steps can be implemented in any order; there are many other variations of the different aspects of the present invention as described above, which are not provided in detail for the sake of brevity; although the present invention has been described in detail with reference to the foregoing embodiments, those of ordinary skills in the art will appreciate that the technical solutions disclosed in the above-mentioned embodiments can still be modified, or some of the technical features thereof can be replaced by equivalents; such modifications or replacements do not depart the essence of the corresponding technical solution from the scope of the technical solutions of embodiments of the present invention.

1. An unmanned aerial vehicle, comprising:
a fuselage, a centroid of the unmanned aerial vehicle being located on the fuselage;
an arm connected to the fuselage; and
a motor, wherein the motor is obliquely mounted on the arm, a projection of an inclination direction of the motor on a horizontal plane forms a preset angle with a connecting line between the motor and the centroid, and the inclination direction of the motor forms an acute angle with a vertical direction.

2. The unmanned aerial vehicle according to claim 1, wherein the fuselage comprises a nose and a tail opposite the nose, the motor comprising:
a first motor and a second motor respectively located at two sides of the nose; and
a third motor and a fourth motor respectively located at two sides of the tail;
wherein the inclination direction of the first motor is opposite to that of the third motor, and
the inclination direction of the second motor is opposite to that of the fourth motor.

3. The unmanned aerial vehicle according to claim 2, wherein the first motor has a same mounting plane as the second motor, and the third motor has the same mounting plane as the fourth motor;
a drop is formed between mounting planes of the first motor and the second motor, and the mounting planes of the third motor and the fourth motor.

4. The unmanned aerial vehicle according to claim 2, wherein the included angle between the first motor and the vertical direction is equal to the included angle between the second motor and the vertical direction; and the included angle between the third motor and the vertical direction is equal to the included angle between the fourth motor and the vertical direction.

5. The unmanned aerial vehicle according to claim 4, wherein the mounting planes of the first motor and the second motor are higher than the mounting planes of the third motor and the fourth motor.

6. The unmanned aerial vehicle according to claim 5, wherein the included angle between the first motor and the vertical direction is smaller than the included angle between the third motor and the vertical direction; or
the included angle between the second motor and the vertical direction is smaller than the included angle between the fourth motor and the vertical direction.

7. The unmanned aerial vehicle according to claim 4, wherein the mounting planes of the first motor and the second motor are lower than the mounting planes of the third motor and the fourth motor.

8. The unmanned aerial vehicle according to claim 7, wherein the included angle between the first motor and the vertical direction is greater than the included angle between the third motor and the vertical direction; or
the included angle between the second motor and the vertical direction is greater than the included angle between the fourth motor and the vertical direction.

9. The unmanned aerial vehicle according to claim 2, wherein the included angle between the motor and the vertical direction satisfies:
$$\frac{{l}_{1}}{tan {α}_{1} sin ( arctan ( \frac{{s}_{1}}{{l}_{1}} ) )} + d = \frac{{l}_{2}}{tan {α}_{2} sin ( arctan ( \frac{{s}_{2}}{{l}_{2}} ) )}$$
where S₁ is a shortest distance from an intersection point of motor shafts of the first motor or the second motor and the horizontal plane to a central axis of the fuselage, S₂ is a distance from the intersection point of the motor shafts of the third motor or fourth motor and the horizontal plane to the central axis of the fuselage, l₁ is the distance from the intersection point of the motor shafts of the first motor or the second motor and the horizontal plane to a plane perpendicular to the central axis of the fuselage, l₂ is the distance from the intersection point of the motor shafts of the third motor or the fourth motor and the horizontal plane to the plane perpendicular to the central axis of the fuselage, α₁ is the included angle between the first motor or the second motor and the vertical direction, and α₂ is the included angle between the third motor or the fourth motor and the vertical direction.

10. The unmanned aerial vehicle according to claim 1, wherein the preset angle ranges from 30° to 150°.

11. The unmanned aerial vehicle according to claim 1, wherein the preset angle is 90°.

12. The unmanned aerial vehicle according to claim 1, wherein the included angle between the motor and the vertical direction is not greater than 15°.

13. The unmanned aerial vehicle according to claim 1, wherein the unmanned aerial vehicle further comprises a motor mount to which the motor is mounted, the motor mount being mounted obliquely to the arm, and the motor mount being at an angle to the horizontal plane that is equal to the angle between the motor and the vertical direction.
